(19) United States
(12) Patent Application Publication
(10) Pub. No.: US 2010/0333020 A1
(43) Pub. Date: Dec. 30, 2010

(54) LIFELOG-BASED LANDMARK DISPLAY APPARATUS AND METHOD

(76) Inventors: Dong Kyun JEONG, Seongnam-si (KR); Jung Hwan Kim, Seoul (KR)

Correspondence Address: North Star Intellectual Property Law, PC, P.O. Box 34688, Washington, DC, 20043, US

(21) Appl. No.: 12/715,453

(22) Filed: Mar. 2, 2010

(30) Foreign Application Priority Data
Jun. 26, 2009 (KR) 10-2009-0057401

(51) Int. Cl. G06F 3/048; G06F 15/16

(52) U.S. Cl. 715/810; 715/853; 709/219; 715/764

(57) ABSTRACT

A landmark display apparatus and method are provided. The landmark display apparatus may extract a landmark from lifelog information, locate the extracted landmark on a time axis, and display the landmark on the time axis. Also, when lifelog information associated with a landmark is displayed, the landmark may be displayed on the displayed lifelog information.

### CROSS-REFERENCE TO RELATED APPLICATION

This application claims the benefit under 35 U.S.C. §119(a) of a Korean Patent Application No. 10-2009-0057401, filed on Jun. 26, 2009, in the Korean Intellectual Property Office, the entire disclosure of which is incorporated herein by reference for all purposes.

### BACKGROUND

1. Field

The following description relates to a landmark display apparatus and method, and more particularly, to a landmark display apparatus and method that may extract a landmark event of a user as a landmark and display the extracted landmark.

2. Description of the Related Art

The amount and the type of information exchanged between mobile terminals are rapidly growing. Initially, mobile terminals were simply recognized as a terminal capable of wireless call functionality. However, a mobile terminal may now provide call functionality, schedule management functionality, games, music playback functionality, email functionality, satellite broadcasting services, photograph services using a digital camera, web surfing services based on wireless Internet, access services to a wireless device using Bluetooth, and the like.

Accordingly, the amount of information stored in a mobile terminal has increased. Also, the stored information may be of various types, for example, text messages, online chat records, information received/transmitted to and from other mobile terminals, photos, emails, appointment information, and the like.

The various types of information and large amounts of information are generated and stored. However, while the information may be in various forms, the information is usually displayed in the form of a list on a display of a mobile terminal. Accordingly, it may not be easy to retrieve desired information when information is displayed only in the form of a list.

### SUMMARY

In one general aspect, provided is a landmark display apparatus, comprising a landmark storage unit to store a landmark indicating a landmark event, and a landmark display unit to check an event time of the landmark and to display the landmark on a screen at a location on a time axis, such that the time axis indicates a time flow on the screen, and the location corresponds to a point in time on the time flow.

The landmark display unit may display at least one of the landmark on the location of the time axis, the landmark using a line connecting the landmark and the location in the time axis, the landmark next to the location in the time axis when the time axis is vertically displayed, and the landmark above or below the location in the time axis when the time axis is horizontally displayed.

The landmark display unit may sense whether a landmark has been selected, and the landmark display unit displays lifelog information about the landmark.

The landmark display unit may display the landmark when lifelog information associated with the landmark is displayed on the screen.

The landmark may be symbolized by at least one of a character string, a photo, and an abstract image, included in the lifelog information.

The abstract image may be generated from the lifelog information.

The landmark display apparatus may further comprise a lifelog generation unit to generate lifelog information associated with a record of daily life, a storage unit to store the lifelog information, and a landmark extraction unit to extract the landmark satisfying a predetermined criterion based upon the lifelog information.

If lifelog information generated in a predetermined time period satisfies the predetermined criterion, the landmark extraction unit may extract the landmark from the combined lifelog information.

The lifelog generation unit may include at least one of a camera, a message management device, a Global Positioning System (GPS), an accelerometer, a schedule management device, an electronic payment device, and a bio-signal measurement device.

The landmark display apparatus may further comprise a communication unit to receive the lifelog information from at least one digital device.

The landmark display apparatus may further comprise a communication unit to receive the landmark from a landmark server extracting the landmark.

The landmark server may receive lifelog information from at least one digital device, and may extract the landmark satisfying a predetermined criterion based upon the lifelog information.

In another aspect, provided is a landmark display method, comprising receiving a request to display a landmark on a time flow axis, checking an event time of the landmark when displaying a screen including a time axis indicating the time flow, and displaying the landmark on a location in the time axis, the location corresponding to the landmark point in time.

The displaying may include at least one of displaying the landmark on the location of the time axis, displaying the landmark using a line connecting the landmark and the location in the time axis, displaying the landmark next to the location in the time axis when the time axis is vertically displayed, and displaying the landmark above or below the location in the time axis when the time axis is horizontally displayed.

The landmark display method may further comprise sensing that a landmark has been selected, and displaying information about the landmark when the landmark is selected and the selection is sensed.

The landmark display method may further comprise displaying the landmark when lifelog information, associated with the landmark, is displayed on the screen.

The landmark may be symbolized by at least one of a character string, a photo, and an abstract image, included in the lifelog information.

The abstract image may be generated from the lifelog information.

The landmark display method may further comprise collecting lifelog information associated with a record of daily life, and extracting the landmark satisfying a predetermined criterion using the lifelog information.

The lifelog information generated in a predetermined time period may satisfy the predetermined criterion, the extracting may include extracting the landmark from the lifelog information.

The lifelog information may be generated through at least one of a camera, a message management device, a GPS, an accelerometer, a schedule management device, an electronic payment device, and a bio-signal measurement device.

The landmark display method may further comprise receiving the lifelog information from at least one digital device.

The landmark display method may further comprise receiving the landmark from a landmark server extracting the landmark.

The landmark server may receive lifelog information from at least one digital device, and may extract the landmark satisfying a predetermined criterion using the lifelog information.

Other features and aspects will be apparent from the following detailed description, the drawings, and the claims

### BRIEF DESCRIPTION OF THE DRAWINGS

FIG. 1 is a diagram illustrating an example of a landmark display apparatus.

FIG. 2 is a diagram illustrating an example of displaying a landmark which is received from the outside.

FIG. 3 is a diagram illustrating an example of generating a landmark.

FIG. 4A is a diagram illustrating an example of displaying a landmark on a time axis.

FIG. 4B is a diagram illustrating an example of displaying a landmark on a message associated with the landmark.

FIG. 5A is a diagram illustrating an example of displaying an image browser and a landmark on an image associated with the landmark.

FIG. 5B is a diagram illustrating an example of displaying a landmark on an image associated with a landmark when the image is displayed.

FIG. 6 is a flowchart illustrating an example method for displaying a landmark.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A lifelog-based landmark display apparatus and method that may extract a landmark event as a landmark and display the extracted landmark are described herein.

The term “lifelog” may indicate various kinds of information, for example, video information, audio information, photographic information, and the like. The lifelog information may be captured and stored using digital devices. Lifelog indicates capturing and storing events and experiences, for example, what a person does, who a person meets with, what a person eats, and the like, and the information may be stored as digital medium like a video, audio, and photo. In general, ‘lifelog’ information may include events and activities of daily life.

Hereinafter, a ‘landmark’ may indicate an event or an incident that a user of a mobile terminal may desire to remember. For example, the user may take a photo, record an audio, record a video, type or write words, and the like.

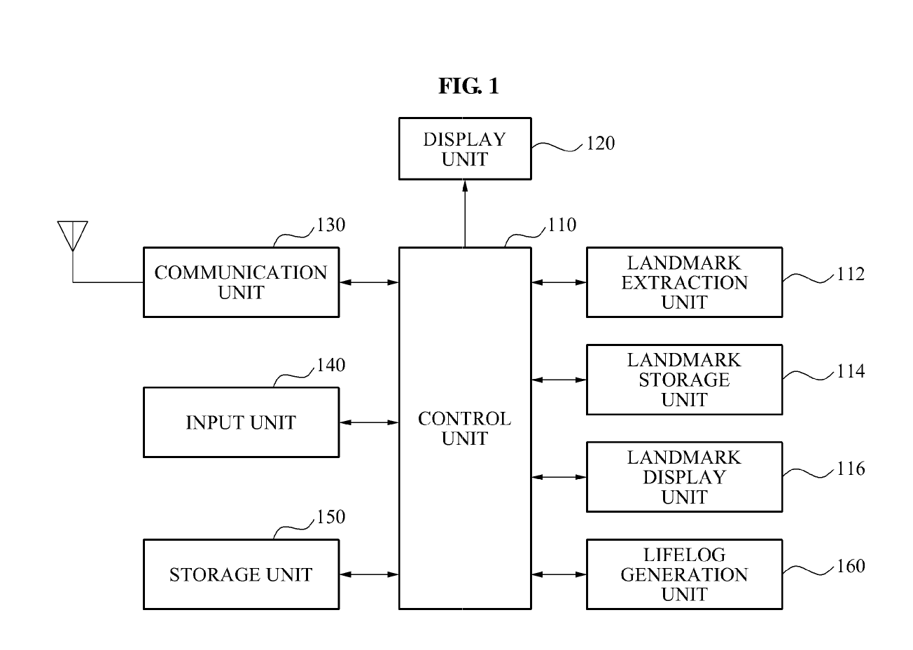

FIG. 1 illustrates an example of a landmark display apparatus 100. Referring to FIG. 1, the landmark display apparatus 100 may include a control unit 110, a landmark extraction unit 112, a landmark storage unit 114, a landmark display unit 116, a display unit 120, a communication unit 130, an input unit 140, a storage unit 150, and a lifelog generation unit 160.

The display unit 120 may display, for example, state information, numbers, characters, photos, and the like, that may be generated during the operation of the landmark display apparatus 100. Also, the display unit 120 may display an output screen including a landmark. The screen may be of any desired material, for example, liquid crystal design (LCD), light emitting diodes (LEDs), organic light emitting diodes (OLEDs), plasma, and the like.

The communication unit 130 may receive the landmark, and transmit or receive lifelog information to generate the landmark.

The input unit 140 may include input devices, for example, a key pad, a touch screen, and the like. The input unit 140 may provide an input of a user to the control unit 110. The key pad or touch screen may include one or more keys, for example, number keys of 0 to 9, menu keys, a cancel key, a confirmation key, navigation keys (▴/▾/ [symbol] / [symbol] ), and the like.

The storage unit 150 may store one or more programs that may be used to control the operation of the landmark display apparatus 100. The storage unit may store lifelog information. For example, the lifelog information may include one or more photos, videos, schedule information, call details, electronic payment information, location information, blood-sugar information, cardiac information, address information, information about a transmission/receiving message, and the like.

The lifelog generation unit 160 may indicate all kinds of devices that may generate lifelog information. For example, the lifelog generation unit 160 may include a camera, a message management device, a Global Positioning System (GPS), an accelerometer, a schedule management device, an electronic payment device, and a bio-signal measurement device.

The landmark extraction unit 112 may extract the landmark based on the lifelog information stored in the storage unit 150, and store the extracted landmark in the landmark storage unit 114. The landmark may indicate a landmark event.

The landmark extraction unit 112 may determine whether the landmark is a landmark event by comparing the lifelog information to a predetermined criterion. For example, the landmark extraction unit 112 may extract the landmark satisfying the predetermined criterion from the lifelog information.

Examples of predetermined criterion may be, for example, whether a related word is sensed at least a predetermined number of times in a predetermined time period from among the lifelog information, whether a message is received or transmitted to or from a particular object at least a predetermined number of times in a predetermined time period, and the like. Any desired information may be extracted from the lifelog information and may be used as the predetermined criterion.

The predetermined criterion may be set by a user. The predetermined criterion may be automatically set by enabling the landmark extraction unit 112 to determine a landmark criterion through clustering of the lifelog information.

The landmark may include, for example, lifelog information corresponding to the landmark, and an event time which is a point in time that the landmark occurs. The landmark may be displayed as one or more of character strings, photos, abstract images, and the like, the string and the photo that are included in the related lifelog information, the image that is generated from related lifelog information.

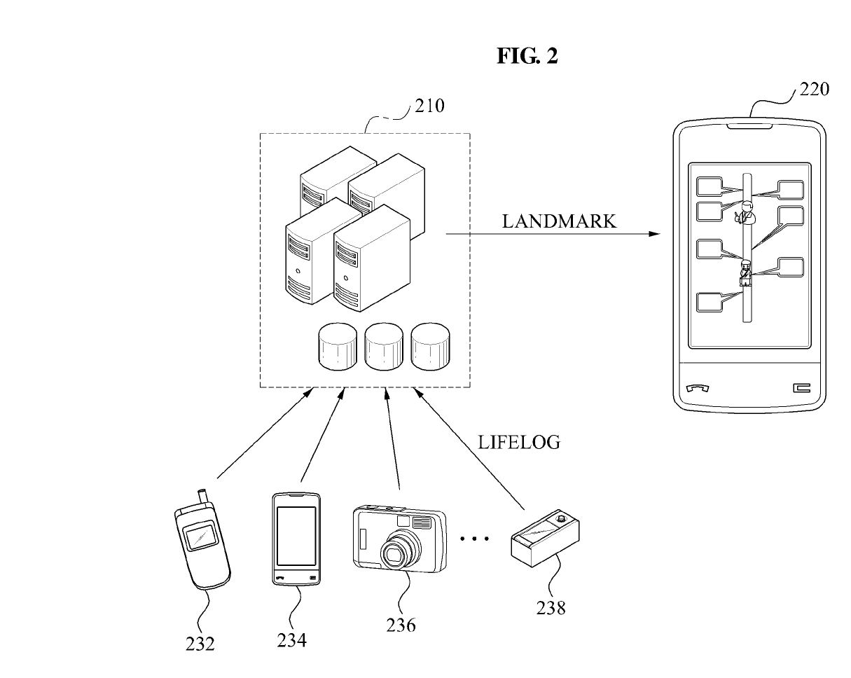

The landmark extraction unit 112 may be located in an external server. A landmark extraction unit 112 located in the external server is described with reference to FIG. 2.

FIG. 2 illustrates an example of displaying a landmark which is received from the outside. Referring to FIG. 2, a system for displaying a landmark may include a landmark server 210 to extract the landmark, a mobile terminal 220 to display the landmark, and one or more terminals, for example, terminals 232, 234, 236, and 238 to provide lifelog information.

The landmark server 210 may receive the lifelog information from the mobile terminal 220 and/or the terminals 232, 234, 236, and 238, extract the landmark from the lifelog information, and transmit the landmark to the mobile terminal 220 and/or the terminals 232, 234, 236, and 238.

The system for displaying a landmark may extract the landmark based on the lifelog information generated by one or more of a plurality of digital devices. The landmark may be extracted using lifelog information received from mobile terminals.

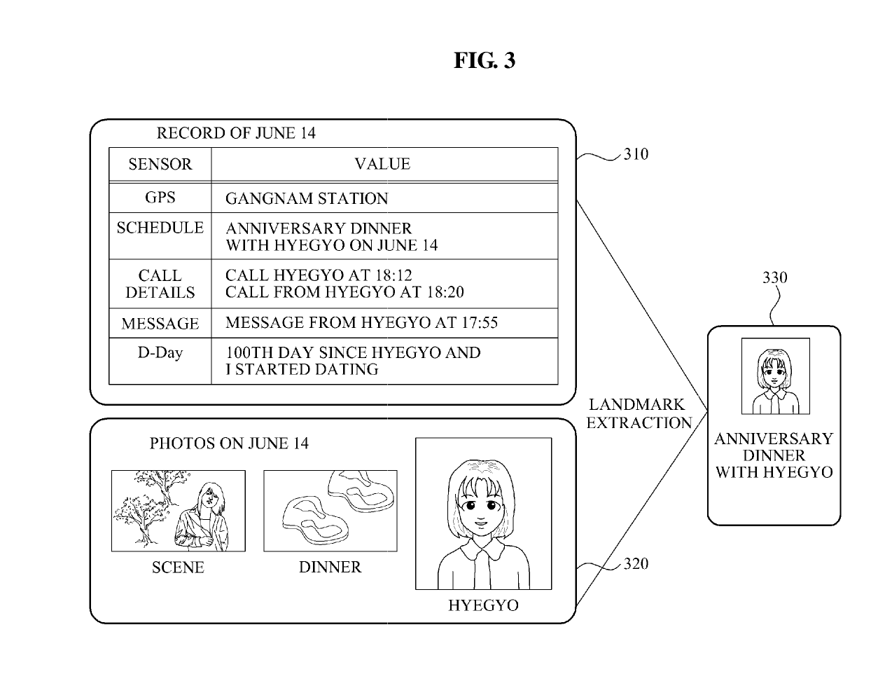

When a predetermined number of related events occur in a point in time when lifelog information is generated, a method may be used to determine that these events correspond to a landmark point in time or a landmark event, and thus a landmark including related lifelog information may be extracted. When a predetermined word or a predetermined event occurs, a landmark including related lifelog information may be extracted. Examples of landmark extraction are described in detail with reference to FIG. 3.

FIG. 3 illustrates an example of generating a landmark. Referring to FIGS. 1-3, the landmark extraction unit 112 or the landmark server 210 may check information about a schedule, call details, transmitted/received messages, and the like, from lifelog information 310. For example,lifelog information including ‘Hyegyo’ of June 14. The lifelog information 310 may be stored in a mobile terminal. The landmark extraction unit 112 or the landmark server 210 may ascertain whether a photo stored, for example, such as ‘Hyegyo’ exists in lifelog information 320 of June 14. The lifelog information 320 may be stored in a camera.

If at least a predetermined number of different pieces of data associated with ‘Hyegyo’ are retrieved, the landmark extraction unit 112 or the landmark server 210 may determine that the lifelog information 310 and 320 is a landmark time or a landmark event, and generate a landmark 330, for example, a landmark named ‘Anniversary dinner with Hyegyo’.

Referring again to FIG. 1, the landmark storage unit 114 may store the extracted landmark. The extracted landmark may include the related lifelog information.

When displaying a time axis indicating a time flow on a screen, the landmark display unit 116 may check an event time of the landmark and display the landmark on a location in the time axis. For example, the location may correspond to an event time.

The landmark may be displayed on the location of the time axis, or displayed using a line connecting the landmark and the location in the time axis. For example, the landmark may be displayed next to the location of the time axis when the time axis is vertically displayed, or displayed above or below the location in the time axis when the time axis is horizontally displayed.

When lifelog information associated with the stored landmark is displayed on the screen, the landmark display unit 116 may display the landmark with the displayed lifelog information. For example, when the landmark display apparatus 100 senses that the displayed landmark is selected, the landmark display unit 116 may display lifelog information associated with the selected landmark.

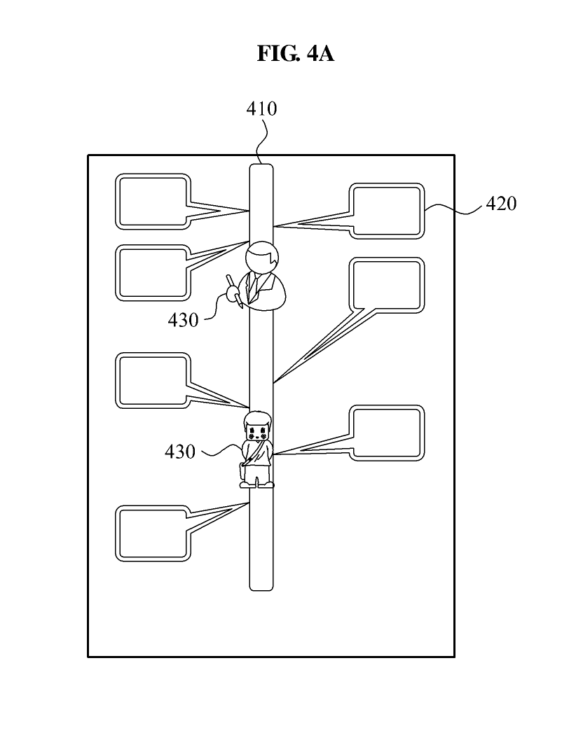

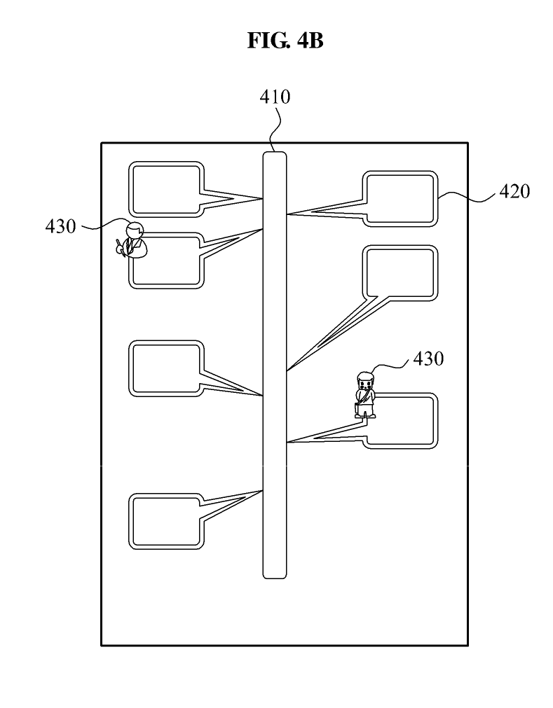

As illustrated in FIGS. 4A and 4B, the time axis may be displayed together with a message on the screen. Photos may be arranged based on the point in time that the photos were taken or the point in time the photos were generated, and displayed together with the time axis. Schedules may be arranged according to a time flow and the time axis may be displayed together with the schedules.

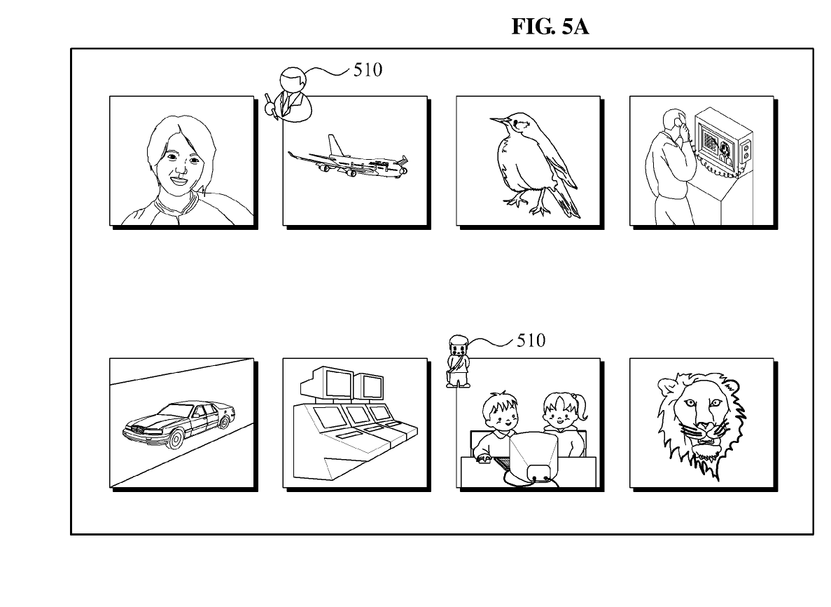

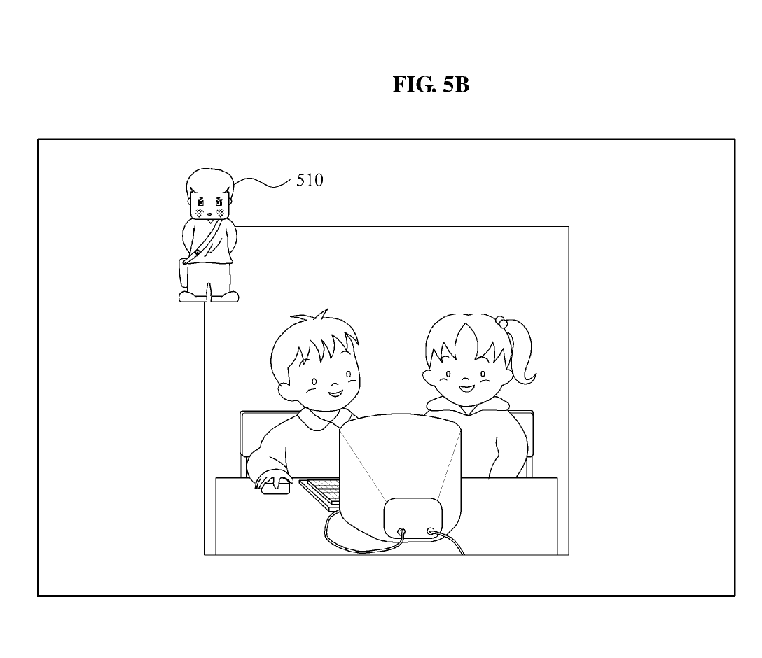

Examples of displaying a landmark are described through FIGS. 4A, 4B, 5A, and 5B.

FIG. 4A illustrates an example of displaying a landmark 430 on a time axis 410. Referring to FIG. 4A, when displaying a message list together with the time axis 410, a landmark display apparatus 100 may check an event time of the landmark 430 and display the landmark 430 on a location of the time axis 410. The location may correspond to the point in time that the landmark was taken or generated.

FIG. 4B illustrates an example of displaying a landmark 430 on a message associated with the landmark 430. Referring to FIG. 4B, when displaying a message list together with a time axis 410, a landmark display apparatus 100 may check the message associated with the landmark 430, and display the landmark 430 on the message.

FIG. 5A illustrates an example of displaying an image browser and a landmark 510 on an image associated with the landmark 510. Referring to FIG. 5A, when displaying the image browser, a landmark display apparatus 100 may check for images associated with the landmark 510, and display the landmark 510 on the images.

FIG. 5B illustrates an example of displaying a landmark on an image associated with a landmark 510, when the image is displayed.

Referring to FIG. 5B, when displaying an image, a landmark display apparatus 100 may check whether the image is associated with the landmark 510, and display the landmark 510 on the image when the image is associated with the landmark.

Referring again to FIG. 1, the control unit 110 may control an operation of the landmark display apparatus 100, and control the landmark extraction unit 112 and the landmark display unit 116. For example, the control unit 110 may function as the landmark extraction unit 112 and the landmark display unit 116. In example, the landmark extraction unit 112 and the landmark display unit 116 are separately configured and illustrated to describe each function. In some embodiments, some or all of the functions of the landmark extraction unit 112 and the landmark display unit 116 may be performed by the control unit 110.

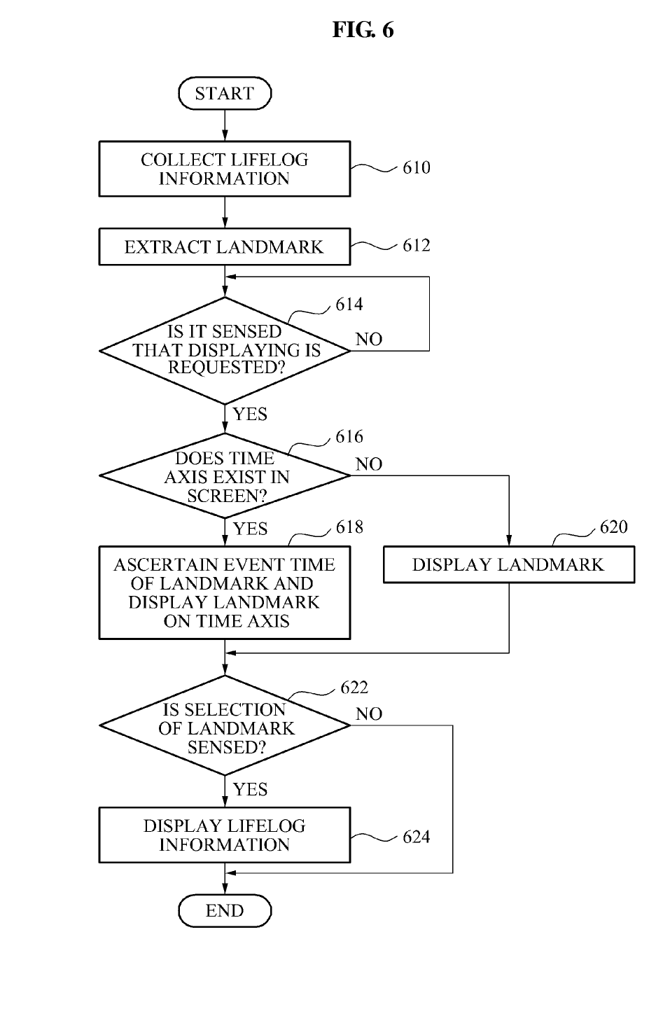

Hereinafter, a landmark display method of the above-described landmark display apparatus 100 is described with reference to FIG. 6.

FIG. 6 illustrates an example of a method for displaying a landmark. Referring to FIG. 6, in 610, the landmark display apparatus 100 may collect lifelog information. In some embodiments, the landmark display apparatus 100 may receive the lifelog information from another terminal.

In 612, the landmark display apparatus 100 may extract the landmark from the collected lifelog information. The landmark display apparatus 100 may receive the landmark extracted from a landmark server.

In 614, the landmark display apparatus 100 may determine whether a request has been made to display the landmark on a screen. In 616, the landmark display apparatus 100 may ascertain whether a time axis exists in the screen display.

When the time axis exists and is ascertained in 616, the landmark display apparatus 100 may check an event time of the landmark and display on the time axis in 618. However, when the time axis does not exist in the screen as a result of the ascertaining in 616, the landmark display apparatus 100 may display the landmark on the lifelog information in 620. Also, when the landmark is set to be displayed on the lifelog information even though the time axis exists as a result of the ascertaining in 616, the landmark display apparatus 100 may display the landmark on the lifelog information.

In 622, the landmark display apparatus 100 may determine whether a selection of the displayed landmark is sensed. In 624, the landmark display apparatus 100 may display lifelog information associated with the selected landmark.

The processes, functions, methods and software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

The landmark display apparatus and method may extract a landmark satisfying a predetermined criterion using lifelog information through a landmark extraction unit, and display a time axis indicating a time flow on a screen. The landmark display apparatus may check an event time of the landmark and display the landmark on a location corresponding to the event time in the time axis through a landmark display unit. Accordingly, the landmark display apparatus and method may display a past event on the time axis as the landmark, and thereby may retrieve information quickly when a user desires to retrieve information such as a message transmitted/received, a photo taken, an appointment of a user, and the like.

Also, the landmark display apparatus and method may display a landmark, generated using lifelog information through a communication unit, and thereby may enable a user to visualize a relationship with others.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A landmark display apparatus, comprising:
a landmark storage unit to store a landmark indicating a landmark event; and
a landmark display unit to check an event time of the landmark and to display the landmark on a screen at a location on a time axis, such that the time axis indicates a time flow on the screen, and the location corresponds to a point in time on the time flow.

2. The landmark display apparatus of claim 1, wherein the landmark display unit displays at least one of the landmark on the location of the time axis, the landmark using a line connecting the landmark and the location in the time axis, the landmark next to the location in the time axis when the time axis is vertically displayed, and the landmark above or below the location in the time axis when the time axis is horizontally displayed.

3. The landmark display apparatus of claim 1, wherein the landmark display unit senses whether a landmark has been selected, and the landmark display unit displays lifelog information about the landmark.

4. The landmark display apparatus of claim 1, wherein the landmark display unit displays the landmark when lifelog information associated with the landmark is displayed on the screen.

5. The landmark display apparatus of claim 1, wherein the landmark is symbolized by at least one of a character string, a photo, and an abstract image, included in lifelog information.

6. The landmark display apparatus of claim 5, wherein the abstract image is generated from lifelog information.

7. The landmark display apparatus of claim 1, further comprising:
a lifelog generation unit to generate lifelog information associated with a record of daily life;
a storage unit to store the lifelog information; and
a landmark extraction unit to extract the landmark satisfying a predetermined criterion based upon the lifelog information.

8. The landmark display apparatus of claim 7, wherein if lifelog information generated in a predetermined time period satisfies the predetermined criterion, the landmark extraction unit extracts the landmark from the combined lifelog information.

9. The landmark display apparatus of claim 7, wherein the lifelog generation unit includes at least one of a camera, a message management device, a Global Positioning System (GPS), an accelerometer, a schedule management device, an electronic payment device, and a bio-signal measurement device.

10. The landmark display apparatus of claim 7, further comprising:
a communication unit to receive the lifelog information from at least one digital device.

11. The landmark display apparatus of claim 1, further comprising:
a communication unit to receive the landmark from a landmark server extracting the landmark.

12. The landmark display apparatus of claim 11, wherein the landmark server receives lifelog information from at least one digital device, and extracts the landmark satisfying a predetermined criterion based upon the lifelog information.

13. A landmark display method, comprising:
receiving a request to display a landmark on a time flow axis;
checking an event time of the landmark when displaying a screen including a time axis indicating the time flow; and
displaying the landmark on a location in the time axis, the location corresponding to the landmark point in time.

14. The landmark display method of claim 13, wherein the displaying includes at least one of displaying the landmark on the location of the time axis, displaying the landmark using a line connecting the landmark and the location in the time axis, displaying the landmark next to the location in the time axis when the time axis is vertically displayed, and displaying the landmark above or below the location in the time axis when the time axis is horizontally displayed.

15. The landmark display method of claim 14, further comprising:
sensing that a landmark has been selected; and
displaying information about the landmark when the landmark is selected and the selection is sensed.

16. The landmark display method of claim 13, further comprising:
displaying the landmark when lifelog information, associated with the landmark, is displayed on the screen.

17. The landmark display method of claim 13, wherein the landmark is symbolized by at least one of a character string, a photo, and an abstract image, included in lifelog information.

18. The landmark display method of claim 17, wherein the abstract image is generated from lifelog information.

19. The landmark display method of claim 13, further comprising:
collecting lifelog information associated with a record of daily life; and
extracting the landmark satisfying a predetermined criterion using the lifelog information.

20. The landmark display method of claim 19, wherein lifelog information generated in a predetermined time period satisfies the predetermined criterion, the extracting includes extracting the landmark from the lifelog information.

21. The landmark display method of claim 19, wherein the lifelog information is generated through at least one of a camera, a message management device, a GPS, an accelerometer, a schedule management device, an electronic payment device, and a bio-signal measurement device.

22. The landmark display method of claim 19, further comprising:
receiving the lifelog information from at least one digital device.

23. The landmark display method of claim 13, further comprising:
receiving the landmark from a landmark server extracting the landmark.

24. The landmark display method of claim 23, wherein the landmark server receives lifelog information from at least one digital device, and extracts the landmark satisfying a predetermined criterion using the lifelog information.
